(19) United States
(12) Patent Application Publication
(10) Pub. No.: US 2005/0051639 A1
(43) Pub. Date: Mar. 10, 2005

(54) Flip & sip drinking straw

(75) Inventors: Dan H. Scott, Richmond, VA (US); Manuel Guerrero, Modena (IT)

Correspondence Address: BURNS DOANE SWECKER & MATHIS L L P, POST OFFICE BOX 1404, ALEXANDRIA, VA, 22313-1404, US

(73) Assignee: Tetra Laval Holdings & Finance SA, Pully (CH)

(21) Appl. No.: 10/893,525

(22) Filed: Jul. 19, 2004

Related U.S. Application Data
(60) Provisional application No. 60/487,579, filed on Jul. 17, 2003.

(51) Int. Cl. A61J 15/00

(52) U.S. Cl. 239/33

(57) ABSTRACT

A locking arrangement for closing the interior passage of a straw is disclosed. The locking arrangement includes a ring that is applied over the closable-end of the straw, and in the alternative, a latch can be provided between the closable-end of the straw.

This application is a Continuation of Provisional Application, Ser. No. 60/487,579, filed Jul. 17, 2003.

### FIELD OF THE INVENTION

The invention is related to drinking straws for use with containers of liquid.

### DESCRIPTION OF THE RELATED ART

U.S. Pat. No. 5,201,460 provides a tubular drinking straw with a biasing member intended to bias the straw in a bent position so that the straw returns to its bent position when not manually deformed into a drinking position.

### BRIEF DESCRIPTION OF THE DRAWING FIGURES

Additional features will be apparent upon a review of the following drawing Figures, in which:

FIG. 1 is a perspective view of an embodiment of a drinking straw;

FIG. 1A is a perspective view of a locking ring for use with a drinking straw;

FIG. 1B is a perspective view of the drinking straw of FIG. 1 in a locked position;

FIG. 2 is a perspective view of an embodiment of a drinking straw;

FIG. 2A is a cross-sectional view of the FIG. 2 drinking straw in a locked position; and

FIG. 3 is a perspective view illustrating an embodiment of a drinking straw.

### DETAILED DESCRIPTION OF EMBODIMENTS OF THE INVENTION

Drinking straws are often used to drink liquid from a container. In order to prevent liquid from being inadvertently spilled in the event that the drink container is knocked over, it is desired to provide the straw some means for sealing the straw to prevent the liquid from flowing through the straw when desired.

A drinking straw with a locking device is provided which is spill-proof and lockable. The straw can be used with any type of liquid container.

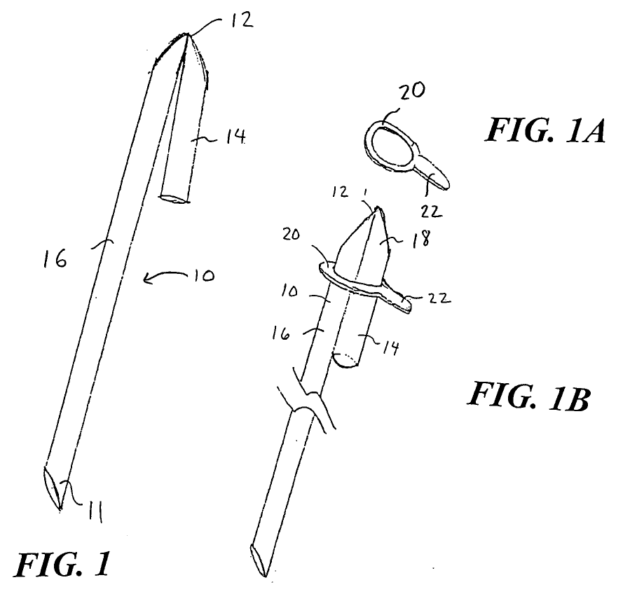

FIG. 1 illustrates a drinking straw 10. The drinking straw 10 can be bent into a position in which the upper end section 14 of the straw is parallel or nearly parallel to the lower end section 16. When in the bent position, the flow path through the straw 10 is sealed and no liquid can flow through the straw. The bend 12 in the straw 10 can be located at any desired distance along the length of the straw. In the embodiment illustrated in FIG. 1, the bend 12 is located in approximately the top ⅓ of the length of the straw 10. In a preferred embodiment, the location of the bend 12 is predetermined and/or the straw is configured to bend at a particular location along the length of the straw 10.

As illustrated in FIG. 1B, a locking mechanism in the form of a locking ring 20 holds the two sections 14 and 16 of the straw 10 in a locked position so the straw 10 remains sealed until the locking ring 20 is removed. The locking ring 20 can be formed of any suitable material, such as, for example, rubber or a food grade material. The locking ring 20 is sized to fit over the bent portion of the drinking straw 10. A tab portion 22 of the locking ring is provided which allows the user to grasp the tab portion 22 for removing the locking ring 20 from the straw.

When the user wishes to drink through the straw, the user unlocks the locking mechanism by removing the locking ring 20 from the bent portion of the drinking straw 10, and straightens the straw so the flow path through the straw is opened, allowing liquid to flow through the straw 10.

The straw 10 can also be resealed. To reseal the straw, the user bends the straw's upper section 14 against the straw's lower section 16, and slides the locking ring 20 over the bent portion 18 of the straw 10.

The drinking straw 10 can be any suitable material, and is preferably formed of food-grade material. The straw 10 can be inserted into the liquid container in either an unlocked or a locked position.

The straw 10 can be used with any type of liquid container. In one embodiment, the straw 10 is used with a container having an opening for receiving the straw which is approximately the same size as the diameter of the straw 10. This embodiment lessens the likelihood of spilling or leakage between the container wall and the outer surface of the straw. The straw 10 can also have a pointed end 11 suitable for piercing the liquid container and/or forming the opening in the container when inserting the straw 10.

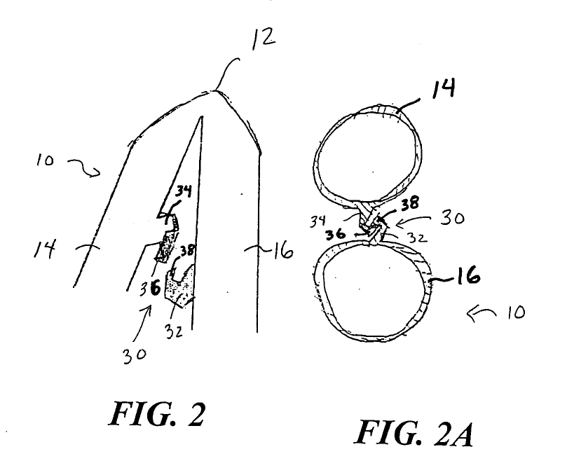

FIG. 2 illustrates an embodiment of a drinking straw 10 having a locking mechanism 30 in the form of two interlocking parts 32 and 34. In FIG. 2, the drinking straw is only partially bent. When the straw 10 is in locked position, the sections 14 and 16 of the straw 10 will be parallel or nearly parallel to each other, and the flow path through the straw 10 will be sealed at the bend 12.

As shown in the cross sectional view of FIG. 2A, the drinking straw 10 is in a locked and sealed position. An interlocking parts 34 extends from the upper section 14 and another interlocking part 32 extends from the lower section 16. The interlocking parts 32 and 34 are positioned and shaped to cooperate with each other. In particular, the interlocking parts can be positioned on the same side of the drinking straw 10 and at approximately the same distance from the bend 12 so that they engage each other when one end of the drinking straw 10 is bent toward the other end.

The interlocking parts 32 and 34 can be of any shape which allows them to be removably interlocked with each other. In the embodiment illustrated in FIGS. 2 and 2a, the interlocking parts extend in a direction away from the surface of the drinking straw portions. Each of the interlocking parts 32 and 34 has an end portion 36 or 38 which is shaped to be held in place by the opposite end portion 38 or 36. Once the interlocking portions 32 and 34 engage each other, the curved end portions 36 and 38 each hold the opposite curved end portions 34 and 32 in the locked position until the user disengages the locking mechanism.

The locking mechanism 30 can be unlocked by the user by manually separates the interlocking parts, and the straw 10 can be straightened to allow liquid to flow through the drinking straw 10. The drinking straw can be resealed by again bending the straw 10 at the bend 12 and again engaging the interlocking parts 32 and 34 with each other.

The locking mechanism 30 components are preferably formed of a food safe material.

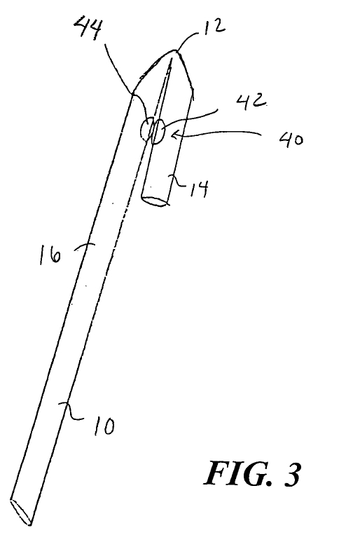

FIG. 3 illustrates a drinking straw 10 with a locking mechanism 40 arranged at a distance from the bend 12. The locking mechanism 40 includes an adhesive area 42 and 44 on each of the drinking straw sections 14 and 16. The adhesive area 42 and 44 preferably include an adhesive which can be resealed a number of times, and which is preferably formed of food-safe material. The adhesive can be a sticky glue point which extends away from the surface of the drinking straw to engage the opposite adhesive area on the other section of the drinking straw.

The locking mechanisms discussed herein can be self contained or can be formed integrally with or attached to the drinking straw during manufacturing.

The embodiments disclosed herein have the advantage that they provide an effective resealable drinking straw which is easy to manufacture and cost effective.

Although only preferred embodiments are specifically illustrated and described herein, it will be appreciated that many modifications and variations of the present invention are possible in light of the above teachings without departing from the spirit and intended scope of the invention.

1. A drinking straw locking device for a drinking straw comprising: a ring having an internal diameter corresponding to about twice the diameter of the straw, and means for returning the ring engaged with the straw when folded, timely closing flow of the liquid through the interior of the straw.

2. A drinking straw locking device comprising: latch means on the exterior of the straw, the straw being adapted for being folded to engage the latch means, whereby the passage through the interior of the straw is closed.
